(19) United States
(12) Patent Application Publication
(10) Pub. No.: US 2015/0029877 A1
(43) Pub. Date: Jan. 29, 2015

(54) DISCOVERY SIGNALS FOR LTE

(71) Applicant: QUALCOMM INCORPORATED, San Diego, CA (US)

(72) Inventors: Wanshi CHEN, San Diego, CA (US); Aleksandar DAMNJANOVIC, Del Mar, CA (US); Peter GAAL, San Diego, CA (US); Tao LUO, San Diego, CA (US); Hao XU, San Diego, CA (US)

(21) Appl. No.: 14/327,709

(22) Filed: Jul. 10, 2014

Related U.S. Application Data
(60) Provisional application No. 61/859,086, filed on Jul. 26, 2013.

(51) Int. Cl. H04W 48/16; H04W 56/00; H04W 52/02; H04W 24/10

(52) U.S. Cl. CPC H04W 48/16; H04W 24/10; H04W 56/001; H04W 52/0209
USPC 370/252; 370/350; 370/311

(57) ABSTRACT

Aspects of the present disclosure relate to techniques that may be utilized in networks with relatively dense deployments of small cells and/or various other types of cells, each of which may or may not support a dormancy cell operation.

### CROSS-REFERENCE TO RELATED APPLICATIONS

The present application for Patent claims priority to U.S. Provisional Application No. 61/859,086, entitled “Discovery Signals for LTE,” filed Jul. 26, 2013, which is assigned to the assignee of the present application and hereby expressly incorporated by reference herein in its entirety.

### TECHNICAL FIELD

Certain aspects of the present disclosure generally relate to wireless communications and, more particularly, to techniques for designing discovery signals.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

Some systems may utilize a relay base station that relays messages between a donor base station and wireless terminals. The relay base station may communicate with the donor base station via a backhaul link and with the terminals via an access link. In other words, the relay base station may receive downlink messages from the donor base station over the backhaul link and relay these messages to the terminals over the access link. Similarly, the relay base station may receive uplink messages from the terminals over the access link and relay these messages to the donor base station over the backhaul link.

### SUMMARY

Certain aspects of the present disclosure provide a method for wireless communications by a node belonging to a plurality of cells. The method generally includes determining that at least one cell in the plurality of cells supports a dormancy state, monitoring for a reference signal in a subframe for the at least one cell, wherein the reference signal is associated with the dormancy state, determining a cell identity (ID) based at least in part on the reference signal, and reporting a measurement, along with the determined cell identity, based at least in part on the reference signal.

Certain aspects of the present disclosure provide an apparatus for wireless communications by a node belonging to a plurality of cells. The apparatus generally includes means for determining that at least one cell in the plurality of cells supports a dormancy state, means for monitoring for a reference signal in a subframe for the at least one cell, wherein the reference signal is associated with the dormancy state, means for determining a cell identity (ID) based at least in part on the reference signal, and means for reporting a measurement, along with the determined cell identity, based at least in part on the reference signal.

Certain aspects of the present disclosure provide an apparatus for wireless communications by a node belonging to a plurality of cells. The apparatus generally includes at least one processor configured to determine that at least one cell in the plurality of cells supports a dormancy state, monitor for a reference signal in a subframe for the at least one cell, wherein the reference signal is associated with the dormancy state, determine a cell identity (ID) based at least in part on the reference signal, and report a measurement, along with the determined cell identity, based at least in part on the reference signal. The apparatus generally also includes a memory coupled with the at least one processor (e.g., with instructions stored thereon for execution by the processor).

Certain aspects of the present disclosure provide a computer-executable storage media comprising program instructions to implement a wireless communication system. The storage media generally include program instructions for determining that at least one cell in the plurality of cells supports a dormancy state, means for monitoring for a reference signal in a subframe for the at least one cell, wherein the reference signal is associated with the dormancy state, means for determining a cell identity (ID) based at least in part on the reference signal, and means for reporting a measurement, along with the determined cell identity, based at least in part on the reference signal.

Certain aspects of the present disclosure provide a method for wireless communications by a base station belonging to a plurality of cells. The method generally includes entering a dormancy state and transmitting a reference signal in a subframe, wherein the reference signal is associated with the dormancy state and conveys at least partial information regarding a cell identity (ID).

Certain aspects of the present disclosure provide an apparatus for wireless communications by a base station belonging to a plurality of cells. The apparatus generally includes means for entering a dormancy state and means for transmitting a reference signal in a subframe, wherein the reference signal is associated with the dormancy state and conveys at least partial information regarding a cell identity (ID).

Certain aspects of the present disclosure provide an apparatus for wireless communications by a base station belonging to a plurality of cells. The apparatus generally includes at least one processor configured to enter a dormancy state and transmit a reference signal in a subframe, wherein the reference signal is associated with the dormancy state and conveys at least partial information regarding a cell identity (ID). The apparatus generally also includes a memory coupled with the at least one processor (e.g., with instructions stored thereon for execution by the processor).

Certain aspects of the present disclosure provide a computer-executable storage media comprising program instructions for entering a dormancy state and transmitting a reference signal in a subframe, wherein the reference signal is associated with the dormancy state and conveys at least partial information regarding a cell identity (ID).

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system, according to aspects of the present disclosure.

FIG. 2 is a block diagram of a communication system, according to aspects of the present disclosure.

FIG. 3 illustrates an example frame structure, according to aspects of the present disclosure.

FIG. 4 illustrates an example subframe resource element mapping, according to aspects of the present disclosure.

FIG. 5 illustrates an example wireless communication system, according to aspects of the present disclosure.

FIGS. 6A-6D illustrate example cell deployment scenarios, in which aspects of the present disclosure may be practiced.

FIG. 7 illustrates example operations that may be performed by a wireless node, according to aspects of the present disclosure.

FIG. 8 illustrates example operations that may be performed by a user equipment (UE), according to aspects of the present disclosure.

### DESCRIPTION

According to certain aspects provided herein, user equipments (UEs) may rely on discovery signals, for example, primary synchronization signal (PSS) and secondary synchronization signal (SSS) to discover cells deployed in a network. However, in relatively dense heterogeneous networks (HetNets) with a plurality of small cells that may support a dormant cell operation, existing discovery signals (e.g., PSS and SSS) may not be sufficient for efficient cell discovery. Accordingly, there may be a need to develop techniques for efficient cell discovery that may allow for discovery of more cells taking into account the dormancy operation for the cells.

As used herein, the term dormant state generally refers to a low power state (e.g., a sleep state) of a cell in which transmissions are limited relative to an active state. Techniques presented herein provide for discovery reference signals for cells in a dormant state (e.g., discovery reference signals transmitted less frequently than discovery signals of cells in an active state).

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

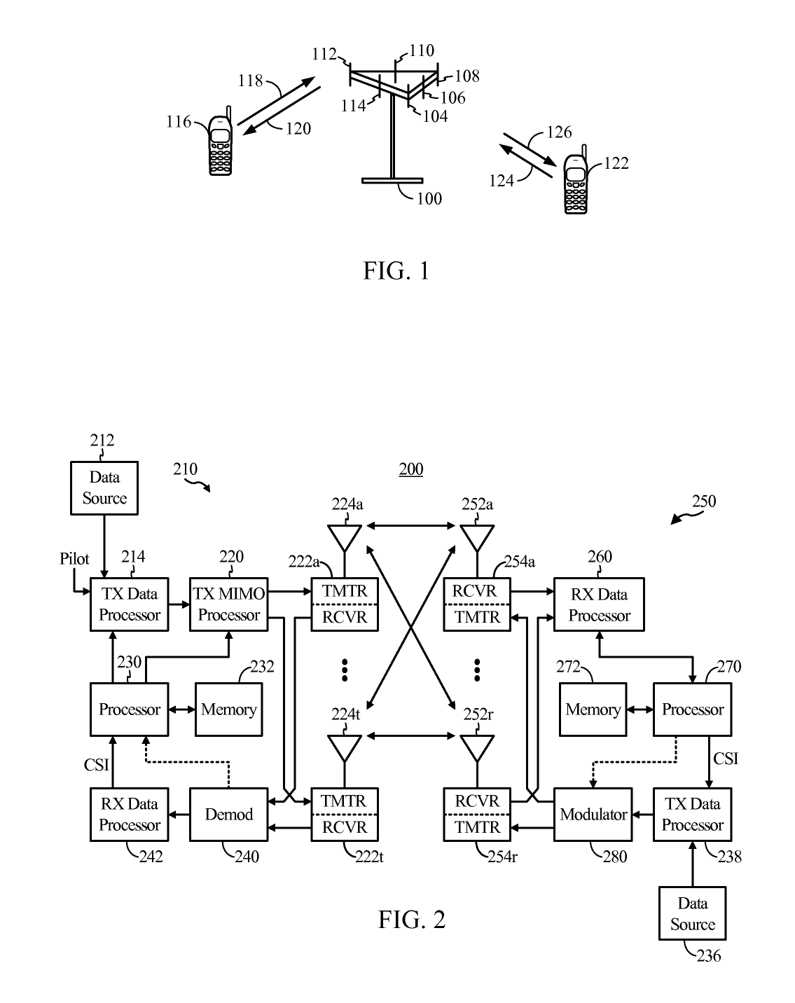

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access point. In the embodiment, antenna groups are each designed to communicate to access terminals in a sector, of the areas covered by access point 100.

In communication over forward links 120 and 126, the transmitting antennas of AP 100 utilize beamforming in order to improve the signal-to-noise ratio of forward links for the different ATs 116 and 124. Also, an AP using beamforming to transmit to ATs scattered randomly through its coverage causes less interference to ATs in neighboring cells than an AP transmitting through a single antenna to all its ATs.

An AP may be a fixed station used for communicating with the terminals and may also be referred to as an access point, a Node B, base station, evolved Node B (eNB) or some other terminology. An AT may also be called an access terminal, user equipment (UE), a wireless communication device, terminal, mobile station or some other terminology.

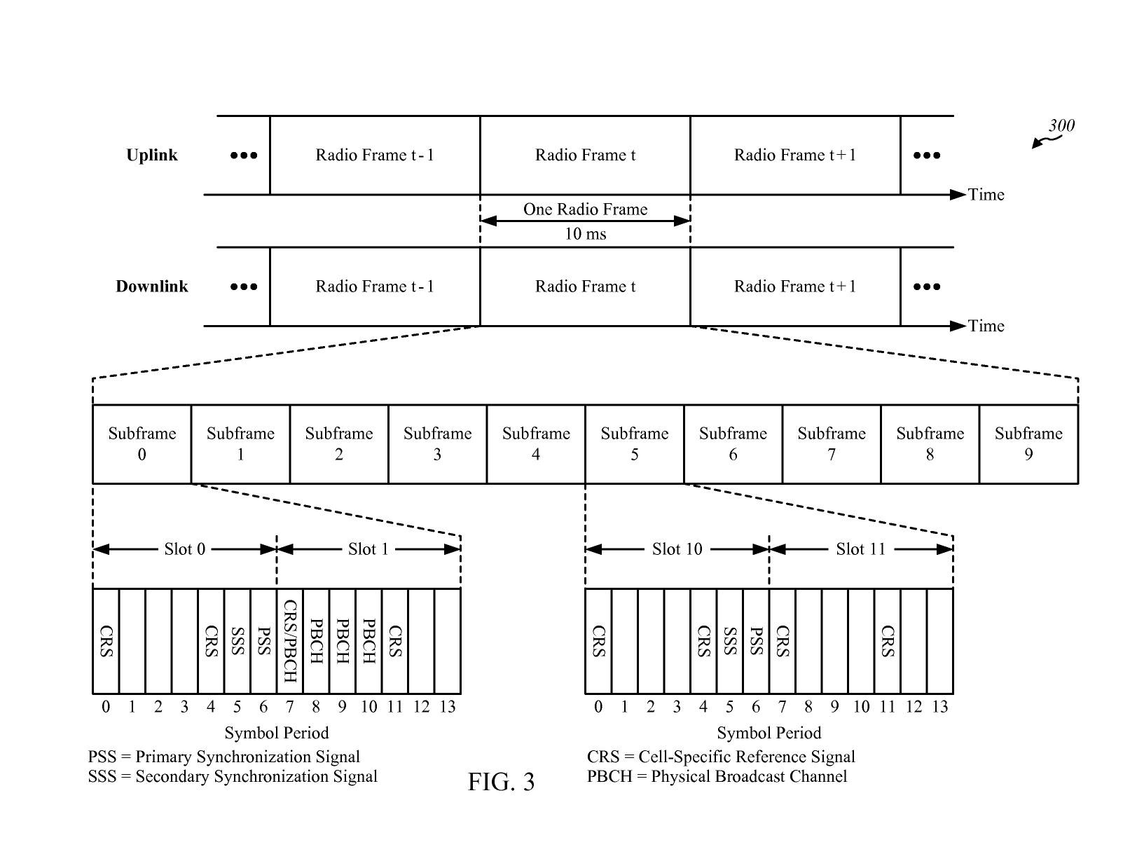

FIG. 2 is a block diagram of an embodiment of a transmitter system 210 (also known as an AP) and a receiver system 250 (also known as an AT) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system 250 to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions, from memory 232, performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r, and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights and then processes the extracted message.

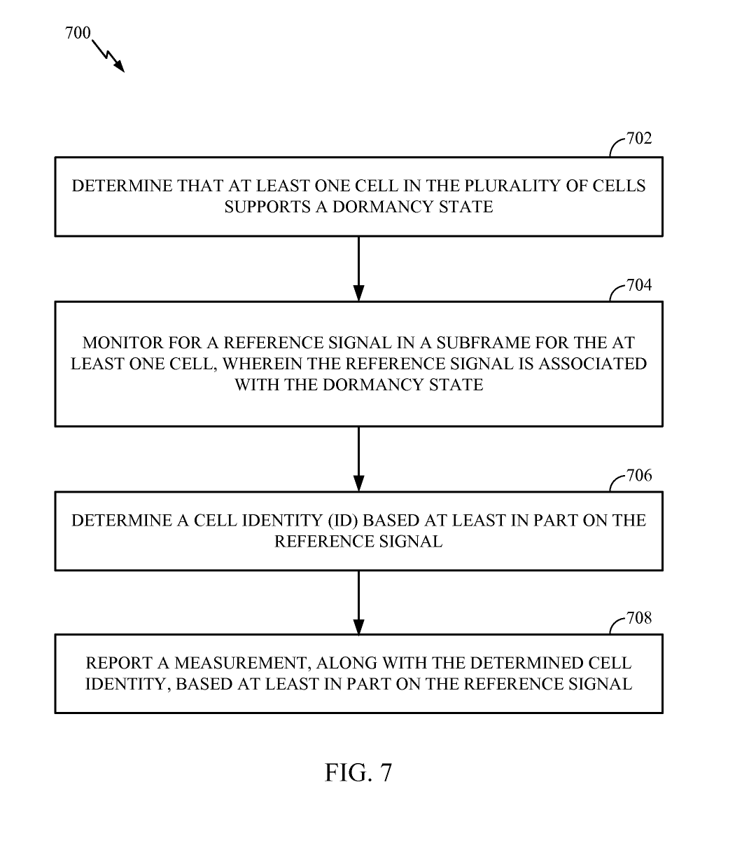

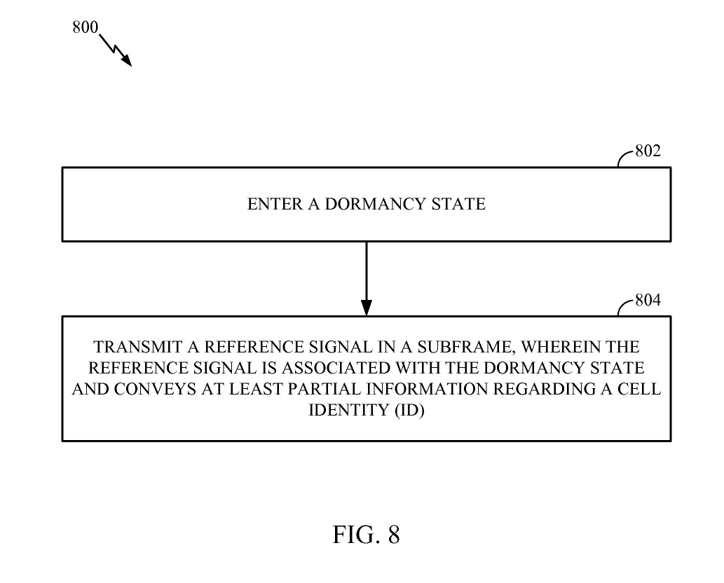

According to aspects, the controllers/processors 230 and 270 may direct the operation at the transmitter system 210 and the receiver system 250, respectively. According to an aspect, the controller/processor 230, TX data processor 214, and/or other processors and modules at the transmitter system 210 may perform or direct operations 700 in FIG. 7 and/or other processes for the techniques described herein. According to another aspect, the controller/processor 270, RX processor 260, and/or other processors and modules at the receiver system 260 may perform or direct operations 800 in FIG. 8 and/or other processes for the techniques described herein. However, any other processor or component in FIG. 2 may perform or direct operations 700 in FIG. 7, operations 800 in FIG. 8 and/or other processes for the techniques described herein. The memories 232 and 272 may store data and program codes for the transmitter system 210 and the receiver system 260, respectively.

In an aspect, logical channels are classified into Control Channels and Traffic Channels. Logical Control Channels comprise Broadcast Control Channel (BCCH), which is a DL channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing an RRC connection, this channel is only used by UEs that receive MBMS (Note: old MCCH+MSCH). Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH), and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Random Access Channel (RACH), a Request Channel (REQCH), an Uplink Shared Data Channel (UL-SDCH), and a plurality of PHY channels. The PHY channels comprise a set of DL channels and UL channels.

The DL PHY channels comprise:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprise:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations apply:

AM Acknowledged Mode

AMD Acknowledged Mode Data

ARQ Automatic Repeat Request

BCCH Broadcast Control CHannel

BCH Broadcast CHannel

C- Control-

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DL-SCH DownLink Shared CHannel

DM-RS DeModulation-Reference Signal

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RB Resource Block

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN Multimedia Broadcast Single Frequency Network

MCE MBMS Coordinating Entity

MCH Multicast CHannel

MSCH MBMS Control CHannel

PDCCH Physical Downlink Control CHannel

PDSCH Physical Downlink Shared CHannel

PRB Physical Resource Block

VRB Virtual Resource Block

In addition, Rel-8 refers to Release 8 of the LTE standard.

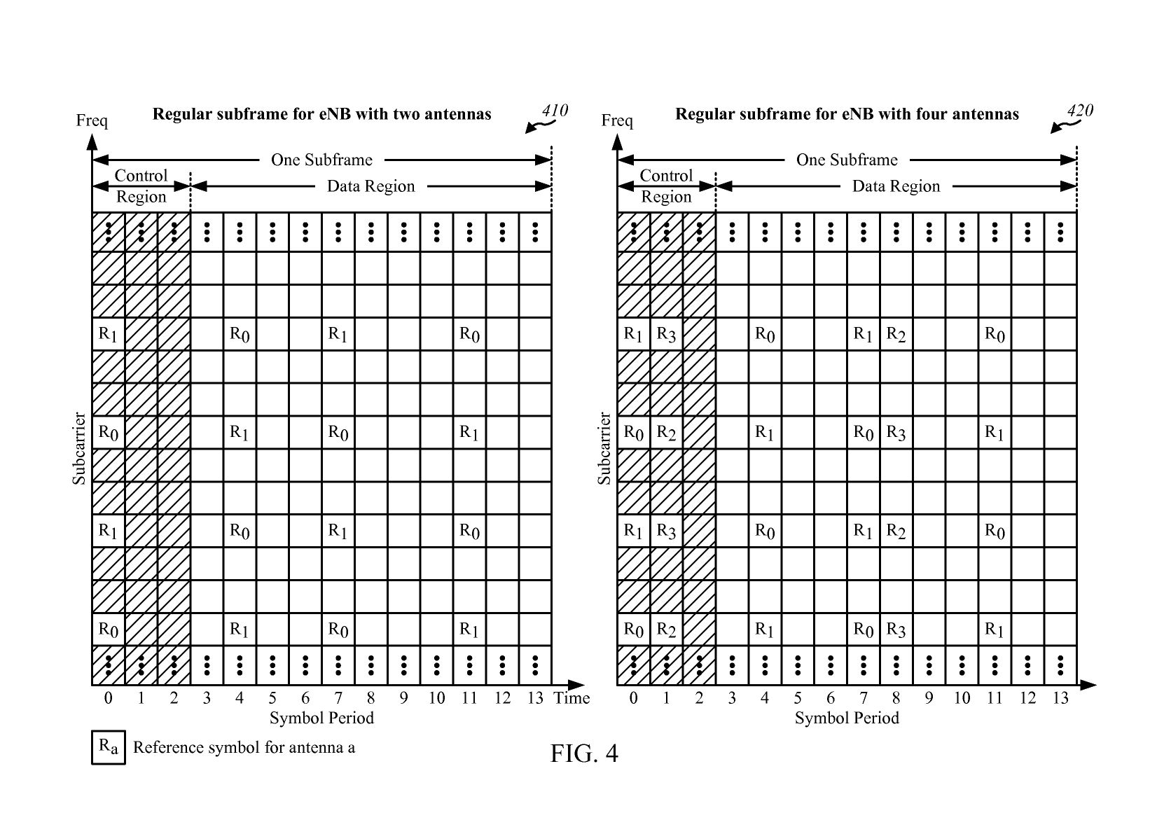

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 3) or six symbol periods for an extended cyclic prefix. The 2L symbol periods in each subframe may be assigned indices of 0 through 2L−1.

In LTE, an eNB may transmit a primary synchronization signal (PSS) and a secondary synchronization signal (SSS) on the downlink in the center 1.08 MHz of the system bandwidth for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The eNB may transmit a cell-specific reference signal (CRS) across the system bandwidth for each cell supported by the eNB. The CRS may be transmitted in certain symbol periods of each subframe and may be used by the UEs to perform channel estimation, channel quality measurement, and/or other functions. The eNB may also transmit a Physical Broadcast Channel (PBCH) in symbol periods 0 to 3 in slot 1 of certain radio frames. The PBCH may carry some system information. The eNB may transmit other system information such as System Information Blocks (SIBs) on a Physical Downlink Shared Channel (PDSCH) in certain subframes. The eNB may transmit control information/data on a Physical Downlink Control Channel (PDCCH) in the first B symbol periods of a subframe, where B may be configurable for each subframe. The eNB may transmit traffic data and/or other data on the PDSCH in the remaining symbol periods of each subframe.

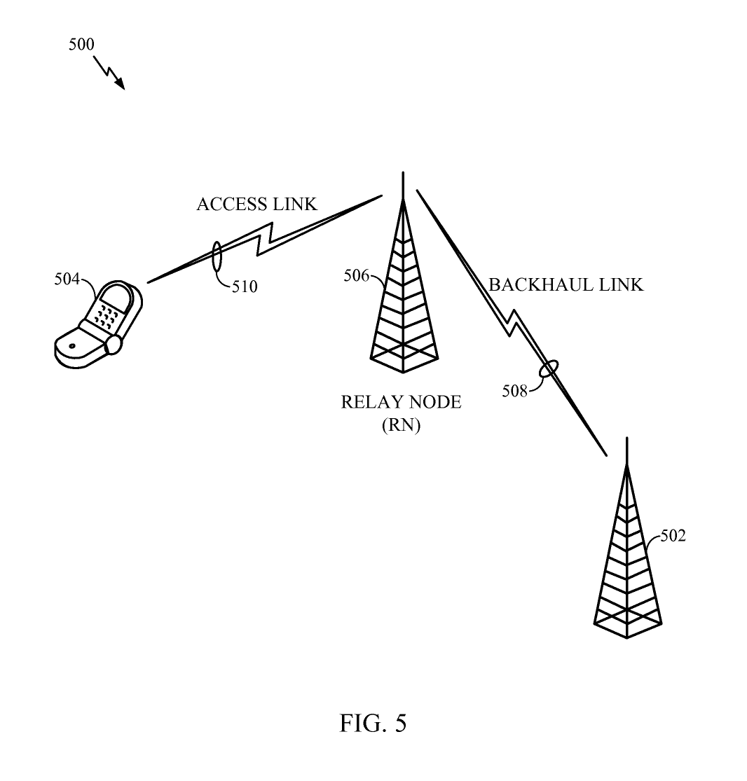

FIG. 4 shows two exemplary subframe formats 410 and 420 for the downlink with the normal cyclic prefix. The available time frequency resources for the downlink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for an eNB equipped with two antennas. A CRS may be transmitted from antennas 0 and 1 in symbol periods 0, 4, 7 and 11. A reference signal is a signal that is known a priori by a transmitter and a receiver and may also be referred to as pilot. A CRS is a reference signal that is specific for a cell, e.g., generated based on a cell identity (ID). In FIG. 4, for a given resource element with label Rₐ, a modulation symbol may be transmitted on that resource element from antenna a, and no modulation symbols may be transmitted on that resource element from other antennas. Subframe format 420 may be used for an eNB equipped with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. Different eNBs may transmit their CRSs on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in LTE. For example, Q interlaces with indices of 0 through Q−I may be defined, where Q may be equal to 4, 6, 8, 10, or some other value. Each interlace may include subframes that are spaced apart by Q frames. In particular, interlace q may include subframes q, q+Q, q+2Q, etc., where qε{0, . . . , Q−1}.

The wireless network may support hybrid automatic retransmission (HARQ) for data transmission on the downlink and uplink. For HARQ, a transmitter (e.g., an eNB) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

A UE may be located within the coverage area of multiple eNBs. One of these eNBs may be selected to serve the UE. The serving eNB may be selected based on various criteria such as received signal strength, received signal quality, pathloss, etc. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering eNBs.

### An Example Relay System

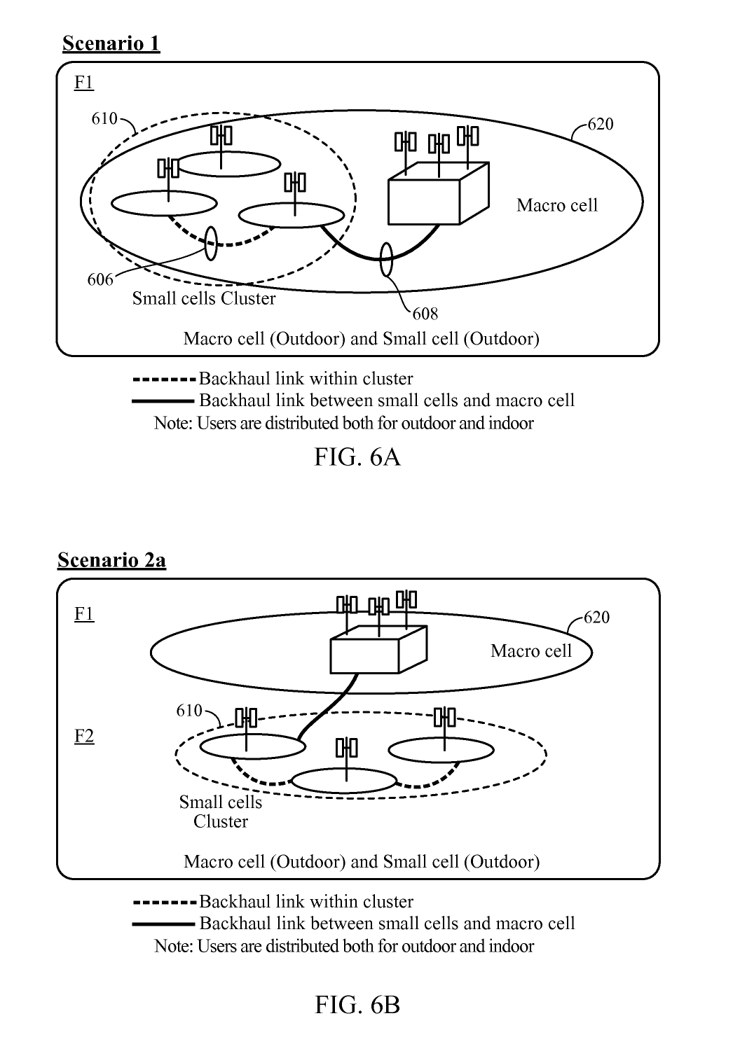

FIG. 5 illustrates an example wireless system 500 in which certain aspects of the present disclosure may be practiced. As illustrated, the wireless system 500 includes a donor base station (BS) 502 that communicates with a user equipment (UE) 504 via a relay node (RN) 506. The RN 506 may communicate with the donor BS 502 via a backhaul link 508 and the relay node 506 may communicate with the UE 504 via an access link 510.

The RN 506 may receive downlink messages from the donor BS 502 over the backhaul link 508 and relay these messages to the UE 504 over the access link 510. RN 506 may, thus, be used to supplement a coverage area and help fill “coverage holes.” According to certain aspects, a RN 506 may appear to a UE 504 as a conventional BS. According to other aspects, certain types of UEs may recognize a RN as such, which may enable certain features.

While the RN 506 is illustrated as a relay BS in FIG. 5, those skilled in the art will appreciate that the techniques presented herein may be applied to any type of device acting as a relay node including, for example, a user equipment (UE) acting as a relay between a donor base station and other UEs. As described herein, a UE acting as a relay node may be referred to as a UE relay (UeNB).

### Example Small Cell Deployment Scenarios for Hyper Dense Heteregenous Networks

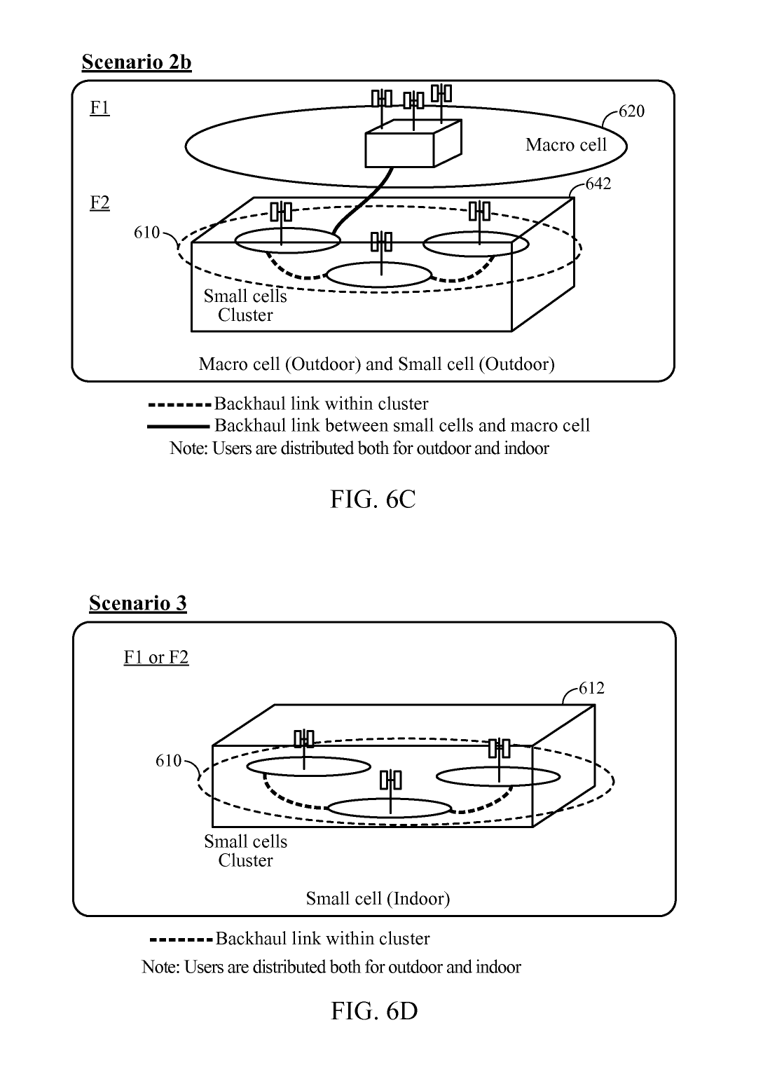

According to certain aspects, in some cases, as capacity needs of wireless communication networks increase, it may be desirable to enhance the coverage of a wireless communication system (e.g., such as wireless system 500). Accordingly, certain aspects of the present disclosure may provide for relatively dense deployment of various types of cells which, in some cases, may boost system performance. According to aspects provided herein, as described in more detail below with reference to FIGS. 6A-6D, different deployment scenarios may have relatively dense deployments of a plurality of various types of cells (e.g., a plurality of small cells in addition to a macro cell). However, aspects of the present disclosure may also provide for a plurality of small cells without the addition of a macro cell.

FIGS. 6A-6D illustrate example deployment scenarios for a wireless communication system, in which aspects of the present disclosure may be practiced. Although four deployment scenarios are illustrated in FIG. 6, aspects of the present disclosure are not meant to be limited to the following deployment scenarios. In fact, one of ordinary skill in the art would understand that aspects of the present disclosure may be practiced in other types of deployment scenarios (e.g., as part of LTE Rel-12) which may have a relatively dense deployment of a plurality of various types of cells.

According to certain aspects, as illustrated in FIG. 6A, a first deployment scenario (e.g., Scenario 1) may include a relatively dense deployment of a plurality of small cells in a small cells cluster 610 in addition to a macro cell 620. As illustrated, in the illustrated example, the small cells cluster 610 and macro cell 620 may both operate on the same frequency band F1. According to certain aspects, the macro cell 620 and small cells cluster 610 may be implemented in an outdoor environment. However, it should be noted that users within the macro cell 620 and small cells cluster 610 may be distributed both indoors and outdoors.

As illustrated in FIG. 6B, in a second scenario (Scenario 2a), the small cells cluster 610 may operate on a second frequency band F2, while macro cell 620 operates on F1. While two frequency bands are illustrated, it should be noted that aspects of the present disclosure may also be practiced in other deployment scenarios with more frequency bands. As illustrated in FIG. 6C, in a similar scenario (Scenario 2b), the small cells cluster 610 may be indoors (e.g., within a building 612).

As illustrated in FIG. 6D, a third deployment scenario (e.g., Scenario 3) may include a relatively dense deployment of a plurality of small cells in the small cells cluster 610 indoors (e.g., within building 612). According to an aspect, the small cells cluster may operate on one or more different frequencies. For example, as illustrated in Scenario 3 of FIG. 6, the small cells cluster 610 may operate on frequency band F1 or frequency band F2.

As illustrated in Scenarios 1, 2a, 2b and 3 of FIGS. 6A-6D, according to certain aspects provided herein, the macro cell 610 and small cells cluster 620 may communicate through a backhaul link between the small cells cluster and macro cell. According to another aspect, the plurality of small cells within the small cells clusters may communicate through a backhaul link between each of the plurality of small cells within the small cells cluster. Further, as described above, according to an aspect, it should be noted that users within the macro cells 620 and/or small cells clusters 610 of Scenarios 1, 2a, 2b and 3 may be distributed both indoors and/or outdoors.

In some cases, as the number of small cell deployments (e.g., such as those illustrated in FIGS. 6A-6D) increase, it may be desirable to more efficiently manage small cells. Accordingly, aspects of the present disclosure may provide one or more techniques for downlink interference avoidance/coordination between nodes belonging to the small cells, which may improve performance associated with the small cells.

According to an aspect of the present disclosure, in some cases, the small cells (e.g., illustrated in FIGS. 6A-6D) may support a dormancy state/operation. According to an aspect, the dormancy state may include a small cell discontinuous transmission (DTX) operation. According to an aspect, the small cell DTX operation may allow a small cell to discontinue its transmission, if beneficial, instead of transmitting in all subframes. According to an aspect, by discontinuing transmission, interference between the plurality of small cells may be reduced. According to another aspect of the present disclosure, in some cases, if there are multiple carriers available in a given cell, the small cells (e.g., illustrated in FIGS. 6A-6D) may support carrier selection, which may allow nodes belonging to the small cells to select, among the different carriers, carriers that may have reduced interference.

According to another aspect of the present disclosure, the small cells (e.g., illustrated in FIGS. 6A-6D) may support one or more techniques for enhanced inter-cell interference coordination (eICIC). According to certain aspects, eICIC techniques may be used to suppress and/or cancel interference between cells. According to aspects, these techniques may include time domain techniques, frequency domain techniques, power domain techniques and/or other techniques, including for example, those described in LTE Rel 10. According to another aspect of the present disclosure, the small cells (e.g., illustrated in FIGS. 6A-6D) may support downlink power adaptation. Cells that support downlink power adaption may be allowed to reduce power to minimize interference and/or optimize efficiency. According to yet another aspect of the present disclosure, the small cells (e.g., illustrated in FIGS. 6A-6D) may support cell selection/association enhancements, which may be used by UEs to improve cell selection in densely packed small cell deployment scenarios.

### Discovery Signal Considerations for Hyper-Dense Het-Nets

In some cases, in general, as the number of cells (e.g., small cells) deployed in heterogeneous networks (HetNets) increase, techniques may be provided to facilitate management of the cells in the HetNet. In one aspect, for relatively dense small cell deployments (e.g., as illustrated in FIGS. 6A-6D), a UE may use discovery signals to identify, within a plurality of cells, a particular node belonging to the plurality of cells. According to certain aspects, discovery signals may also be used for load balancing and interference coordination (including on/off operation), autonomous configuration of new small cells, and mobility robustness (allowing small cells to be identified as a device moves through the small cells).

According to aspects of the present disclosure provided herein, existing primary synchronization signal (PSS), secondary synchronization signal (SSS) and cell reference signal (CRS) may be used for discovery signals. However, as described above, for densely packed small cell deployments, the use of PSS, SSS and CRS may not be sufficient. For example, in some cases, under synchronous deployments, the PSS and SSS of different cells may collide with each other. In this situation, in general, the number of cells that can be detected and/or discovered by a UE may be limited. To address this, according to certain aspects provided herein, PSS and SSS interference cancellation (IC) may be used to facilitate discovering more cells, which may be sufficient in some cases (e.g., for synchronous deployments). However, in some cases, when cells in a network support a dormancy mode, such as discontinuous transmit (DTX) modes, PSS and SSS interference cancellation may not be sufficient due to sparse transmissions by cells that are in the dormancy mode (e.g., a sleep or other low power state where transmissions are limited).

Accordingly, for relatively dense (or hyperdense) cell deployments (e.g., as illustrated in FIGS. 6A-6D), there may be a need for discovery signals that provide for enhanced discovery of cells, including cells in a non-dormancy state (i.e., active state) as well as cells in a dormancy state.

### Example Discovery Signals for Hyperdense Het-Nets

Aspects of the present disclosure provided herein may address the above issues related to cell discovery when some cells may be in a dormancy state. For example, certain aspects provide techniques for designing discovery signals that may take into account dormancy operation for small cells, which may provide for efficient cell discovery. In some cases, the techniques presented herein may be implemented using formats of existing types of reference signals (e.g., PSS, SSS, and/or CRS), but with altered transmission characteristics.

According to aspects of the present disclosure provided herein, if cells of a hyperdense HetNet (e.g., as illustrated in FIGS. 6A-6D) do not support a dormant cell operation, then the use of PSS and SSS for discovery signals and/or PSS and SSS IC may be sufficient. In other words, for non-dormant cells, transmission of these signals may be predictable enough to allow for adequate discovery.

However, if cells of a hyperdense HetNet (e.g., as illustrated in FIGS. 6A-6D) support a dormant cell operation, then certain aspects of the present disclosure may provide for cell discovery based, at least in part, on whether a node belonging to the plurality of cells (e.g., cells in a hyperdense HetNet) is in a dormancy state or non-dormancy state (i.e., active state).

According to certain aspects, for dormant nodes belonging to a plurality of cells, a new discovery reference signal, in general, called a ternary synchronization signal (TSS) for convenience may be transmitted by the dormant nodes. It may be referred to as ternary because it may have different transmission characteristics than a conventional primary synchronization signal (PSS) or a secondary synchronization signal (SSS).

The TSS may uniquely identify the node within the plurality of cells. According to certain aspects, the TSS may be a newly designed format. According to certain aspect, however, the TSS may use a same physical layer sequence design as SSS. For example, the TSS may use a Chu sequence or binary sequence similar to SSS. According to yet another aspect, the TSS may contain at least as much cell ID information for the plurality of cells as the combination of PSS and SSS. For example, according to an implementation, the TSS may contain information for up to 504 IDs. In another example, according to another implementation, the TSS may contain information for more than 504 IDs.

According to certain aspects provided herein, one or more symbols may be used to transmit the TSS. In an implementation, a fixed location of one or more symbols across the plurality of cells may be used to transmit the TSS in different subframes. For example, according to an aspect, the symbol locations of TSS may occupy the current symbol locations used to transmit SSS and/or PSS. For this implementation, TSS interference cancellation (IC) may also be used to improve cell discovery.

In another implementation, a cell dependent location of one or more symbols may be used to transmit the TSS. For example, according to an aspect, the location of one or more symbols used to transmit the TSS may be a function of a cell ID. In another example, the location of one or more symbols used to transmit the TSS may be a function of a group ID or frequency shift. According to certain aspects, there may be three groups and the group ID may be conveyed in the PSS. According to certain aspects, with group ID dependency, the number of locations may be dependent on the number of group IDs (e.g., three locations may be defined in an example where there are three group IDs).

According to yet another aspect, the TSS may or may not occupy the same symbol locations, within a subframe, as symbol locations used to transmit the PSS or SSS in the same or other subframes. For example, the TSS may be transmitted in subframe 5, in symbols 1, 2, and 3 of the 2^{nd} slot, which may correspond to PBCH symbols in subframe 0.

According to yet another aspect, the bandwidth used to transmit the TSS may be configurable. For example, in an implementation, the TSS may occupy the center 6 RBs of a subframe. However, aspects of the present disclosure may provide for other bandwidths and/or frequency locations. A UE may determine which bandwidth to monitor, for example, by blind detection or the UE may be signaled which bandwidth to monitor (e.g., via a broadcast or unicast message).

FIG. 7 illustrates example operations 700 for wireless communications that may be performed by a wireless node, in accordance with aspects of the present disclosure. The wireless node may be a node belonging to a plurality of cells having at least one of a macro node and/or a plurality of various other types of nodes.

The operations 700 begin, at 702, by determining that at least one cell in the plurality of cells supports a dormancy state. At 704, the wireless node monitors for a reference signal in a subframe for the at least one cell, wherein the reference signal is associated with the dormancy state. At 706, the wireless node determines a cell identity (ID) based at least in part on the reference signal. At 708, the wireless node reports a measurement, along with the determined cell identity, based at least in part on the reference signal.

As described above, according to an aspect, the transmitting may comprise transmitting at least the TSS if it is determined that the node is in the dormancy state. According to certain aspects, the transmitting may comprise transmitting the TSS, but not the PSS or SSS, if it is determined that the node is in the dormancy state.

According to another aspect, the transmitting may comprise transmitting at least the PSS and SSS if it is determined that the node is in the non-dormancy state (i.e., active state). For example, according to an aspect, if the node is in an active cell, PSS and SSS may be transmitted as usual. However, in some cases, PSS and SSS IC may still be used for efficient cell discovery. In addition, according to another aspect, TSS may also be transmitted. Accordingly, this aspect may enable UEs to perform discovery for both dormant and non-dormant cells at the same time when UEs discover and measure cells. However, the TSS transmission in addition to PSS/SSS may not be used if TSS, PSS and SSS are always in the same subframe across the plurality of cells. According to yet another aspect, the transmitting may comprise transmitting the TSS less often than the PSS and SSS if it is determined that the node is in the non-dormancy state. For example, the TSS may be transmitted, in some cases, e.g., every 100 ms or 200 ms.

According to yet another aspect, the transmitting may comprise providing signaling to a user equipment (UE) indicating at least one of: which cells of the plurality of cells or which resources the UE should monitor for the TSS. As described in more detail below, according to certain aspects, the signaling may be indicated via broadcast (e.g., in system information blocks (SIBs)) or via unicast signaling from active cells.

FIG. 8 illustrates example operations 800 for wireless communications that may be performed by a base station (BS or eNB), in accordance with aspects of the present disclosure. According to an aspect, the user equipment may be within a plurality of cells having at least one of a macro node and/or a plurality of various other types of nodes.

The operations 800 begin, at 802, entering a dormancy state. At 804, the BS transmitting a reference signal in a subframe, wherein the reference signal is associated with the dormancy state and conveys at least partial information regarding a cell identity (ID).

As described above, the UE may generate and send a report comprising a measurement of the reference signal, along with a cell ID determined by the UE, based at least in part on the reference signal. In some cases, the BS may transmit a primary synchronization signal (PSS) and secondary synchronization signal (SSS) in the subframe (as the reference signal or in addition to the reference signals.

In some cases, the BS may provide, to one or more UEs, signaling indicating at least one of: which cells of the plurality of cells to monitor for the reference signal, which subframes to monitor for the reference signal, or which resources to monitor for the reference signal. The signaling may be provided via a unicast transmission from a cell that is not in the dormancy state.

In some cases, the BS may provide an indication the BS is associated with a cell in the plurality of cells that supports a dormancy state, via at least one of a broadcast message or a unicast message. In some cases, how the BS transmits the reference signal depends, at least in part, on whether all nodes in the plurality of cells communicate on a same frequency band or different frequency bands.

In some cases, the reference signal may convey at least as much cell ID information for the plurality of cells as conveyed by a combination of a primary synchronization signal (PSS) and secondary synchronization signal (SSS). The reference signal may be transmitted at a fixed location of one or more symbols in different subframes. In some cases, the reference signal is transmitted at a location of one or more symbols, wherein the location is a function of at least one of a cell ID, a group ID, or a subframe index. In some cases the reference signal may be transmitted in a bandwidth, selected from a plurality of bandwidths.

As described above, according to aspects, the UE may receive signaling indicating at least one of: which cells of the plurality of cells or which resources to monitor for the TSS. According to aspects, the signaling may be provided via a broadcast system information block (SIB) or via a unicast transmission from an active cell that may transmit the TSS when in a dormancy state.

According to an aspect, the UE may rely on active cells for time/frequency tracking before performing discovery and/or measurements for dormant cells. The measurement may include at least one of a reference signal received power (RSRP), a reference signal received quality (RSRQ), or a reference signal strength indicator (RSSI).

According to another aspect, how the UE monitors for the TSS may depend, at least in part, on whether all nodes in the plurality of cells communicate on a same frequency band or different frequency bands. For example, UEs may rely on different signaling for intra-frequency cells than intra-frequency cells, since the number of cells, latency requirements, etc. for discovery may be different for the two cases.

According to yet another aspect, how the UE monitors for the TSS may depend, at least in part, on whether the UE is in an idle state or a connected state. For example, according to certain aspects, connected UEs may be indicated more frequent discovery signal transmissions than idle UEs, who may rely on a limited set of subframes for discovery.

The various operations of methods described above may be performed by any suitable combination of hardware and/or software component(s) and/or module(s).

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. As used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for wireless communications by a user equipment (UE) within a plurality of cells, comprising:
determining that at least one cell in the plurality of cells supports a dormancy state;
monitoring for a reference signal in a subframe for the at least one cell, wherein the reference signal is associated with the dormancy state;
determining a cell identity (ID) based at least in part on the reference signal; and
reporting a measurement, along with the determined cell ID, based at least in part on the reference signal.

2. The method of claim 1, further comprising monitoring a primary synchronization signal and secondary synchronization signal in the subframe.

3. The method of claim 1, further comprising receiving signaling indicating at least one of: which cells of the plurality of cells to monitor for the reference signal, which subframes to monitor for the reference signal, or which resources to monitor for the reference signal.

4. The method of claim 3, wherein the signaling is provided via a unicast transmission from a cell that is not in the dormancy state.

5. The method of claim 1, wherein the determination that at least one cell in the plurality of cells supports a dormancy state is based on at least one of a broadcast message or a unicast message.

6. The method of claim 1, wherein how the UE monitors for the reference signal depends, at least in part, on whether the UE is in an idle state or a connected state.

7. The method of claim 1, wherein how the UE monitors for the reference signal depends, at least in part, on whether all nodes in the plurality of cells communicate on a same frequency band or different frequency bands.

8. The method of claim 1, wherein the UE determines, from the reference signal, at least as much cell ID information for the plurality of cells as conveyed by a combination of a primary synchronization signal and secondary synchronization signal.

9. The method of claim 1, wherein monitoring for the reference signal comprises monitoring a fixed location of one or more symbols in different subframes.

10. The method of claim 1, further comprising, determining a location of one or more symbols to monitor for the reference signal as a function of at least one of a cell ID or a subframe index.

11. The method of claim 1, further comprising, determining a location of one or more symbols to monitor for the reference signal as a function of a group ID.

12. The method of claim 1, further comprising determining a bandwidth for monitoring the reference signal from a plurality of bandwidths.

13. An apparatus for wireless communications by a user equipment (UE) within a plurality of cells, comprising:
means for determining that at least one cell in the plurality of cells supports a dormancy state;
means for monitoring for a reference signal in a subframe for the at least one cell, wherein the reference signal is associated with the dormancy state;
means for determining a cell identity (ID) based at least in part on the reference signal; and
means for reporting a measurement, along with the determined cell ID, based at least in part on the reference signal.

14. A method for wireless communications by a base station (BS) within a plurality of cells, comprising:
entering a dormancy state; and
transmitting a reference signal in a subframe, wherein the reference signal is associated with the dormancy state and conveys at least partial information regarding a cell identity (ID).

15. The method of claim 14, further comprising receiving, from a UE, a report comprising a measurement of the reference signal, along with a cell ID determined by the UE, based at least in part on the reference signal.

16. The method of claim 14, further comprising transmitting a primary synchronization signal and secondary synchronization signal in the subframe.

17. The method of claim 14, further comprising providing, to one or more UEs, signaling indicating at least one of: which cells of the plurality of cells to monitor for the reference signal, which subframes to monitor for the reference signal, or which resources to monitor for the reference signal.

18. The method of claim 17, wherein the signaling is provided via a unicast transmission from a cell that is not in the dormancy state.

19. The method of claim 14, further comprising providing an indication the BS is associated with a cell in the plurality of cells that supports a dormancy state, via at least one of a broadcast message or a unicast message.

20. The method of claim 14, wherein how the BS transmits the reference signal depends, at least in part, on whether all nodes in the plurality of cells communicate on a same frequency band or different frequency bands.

21. The method of claim 14, wherein the reference signal conveys, at least as much cell ID information for the plurality of cells as conveyed by a combination of a primary synchronization signal and secondary synchronization signal.

22. The method of claim 14, wherein the reference signal is transmitted at a fixed location of one or more symbols in different subframes.

23. The method of claim 14, wherein the reference signal is transmitted at a location of one or more symbols, wherein the location is a function of at least one of a cell ID, a group ID, or a subframe index.

24. The method of claim 14, further comprising determining a bandwidth for transmitting the reference signal from a plurality of bandwidths.

25. An apparatus for wireless communications by a base station (BS) within a plurality of cells, comprising:
means for entering a dormancy state; and
means for transmitting a reference signal in a subframe, wherein the reference signal is associated with the dormancy state and conveys at least partial information regarding a cell identity (ID).
